(19) United States
(12) Patent Application Publication
(10) Pub. No.: US 2024/0073255 A1
(43) Pub. Date: Feb. 29, 2024

(54) GROUP LISTENING SESSION DISCOVERY

(71) Applicant: Spotify AB, Stockholm (SE)

(72) Inventors: Rafael Lucena Araujo, Stockholm (SE); Erik Botes, Stockholm (SE)

(73) Assignee: Spotify AB, Stockholm (SE)

(21) Appl. No.: 17/898,191

(22) Filed: Aug. 29, 2022

(51) Int. Cl. H04L 65/1069; H04N 21/63

(52) U.S. Cl. CPC H04L 65/1069; H04N 21/632

(57) ABSTRACT

In general, this disclosure is directed to generating and discovering a group media playback session that is conducted in a media playback device. One aspect is a method of controlling a media output device, the method comprising establishing a media playback session at a host device through the media output device, wirelessly broadcasting a participant ID from a participant device to the host device, associating, at the host device, the participant ID with a session ID for the media playback session and sending the association to a server, and transmitting session information from the server to the participant device to permit the participant device to join the media playback session to adjust playback at the media output device.

### BACKGROUND

Media content playback is traditionally designed to be controlled by a single interface. For example, a stereo in a car or home typically have a single interface for selecting media and adjusting playback. A vehicle, for example, typically has a single vehicle head unit configured to be controlled by the driver and/or passengers. Similarly, Bluetooth® speakers typically pair with a single media playback device to provide and control audio output. Similar limitations for controlling media output also exist when using other wireless speaker protocols, wired speakers, and other media output devices.

### SUMMARY

In general terms, this disclosure is directed to generating and discovering a media playback session that is conducted in a media playback device. Various aspects are described in this disclosure, which include, but are not limited to, the following aspects.

One aspect is a method of controlling a media output device, the method comprising establishing a media playback session at a host device through the media output device, wirelessly broadcasting a participant ID from a participant device to the host device, associating, at the host device, the participant ID with a session ID for the media playback session and sending the association to a server, and transmitting session information from the server to the participant device to permit the participant device to join the media playback session to adjust playback at the media output device.

Another aspect is a user computing device comprising a processing device, and a memory device storing instructions which, when executed by the processing device, cause the user computing device to receive a request to discover a nearby group listening session, generate a participant ID, wirelessly broadcasting the participant ID, periodically send a discovery request to a server for discoverable group listening sessions, and receive, from the server, a session ID, wherein the session ID allows the user computing device to join a group listening session associated with the session ID, wherein the session ID is generated at a computing device hosting the associated group listening session in response to scanning the wirelessly broadcasted participant ID, and wherein the computing device hosting the associated group listening session sends the generated session ID and the wirelessly broadcasted participant ID to the server.

A further aspect a user computing device hosting a group listening session, the user computing device comprising a processing device, and a memory device storing instructions which, when executed by the processing device, cause the user computing device to establish the group listening session, scan for a participant ID being wirelessly broadcasted from a participant device, identify the participant ID, generate a session ID, and send the participant ID and the unique session ID to a server configured to provide the session ID to the participant device thereby allowing the participant device to discover and join the group listening session.

### BRIEF DESCRIPTION OF THE DRAWINGS

Various embodiments will be described in detail with reference to the drawings, wherein like reference numerals represent like parts and assemblies throughout the several views.

FIG. 1 illustrates an example environment for discovering a group listening session.

FIG. 2 is a schematic diagram of a group media playback discovery system.

FIG. 3. illustrates an example method for discovering a media playback session.

FIG. 4 is a system-flow diagram illustrating an example method for discovering a group listening session.

FIG. 5 illustrates an example method for establishing a discoverable group listening session.

FIG. 6 illustrates an example method for identifying and associating a participant with a group listening session.

FIG. 7 illustrates an example method for discovering a group listening session from a participant device.

FIG. 8 illustrates an example method for managing the discovery of group listening sessions at a discovery server.

FIG. 9 illustrates example user interfaces for discovering and joining a media playback session.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Methods and systems for discovering and controlling a group listening session (sometimes referred to as a group media playback session or media playback session) are disclosed herein, including configurations permitting multiple computing devices to control media playback at host device. In some instances, it may be desired to allow multiple devices to control the media playback at a host device (e.g., a host media playback device). In some embodiments, participants are able to discover and connect their participant devices to a group media playback session of the host device, without requiring involvement by the host user and without requiring the participants to join a common network with the host device. Once a participant joins the media playback session, both the host and the participant are able to use their respective devices to adjust and control the media playback of the group media playback session. In some embodiments, participant devices are able to control the volume of the playback. In some embodiments, the host user can control permissions for the participant devices including identifying controls or types of controls the users of the participant devices can use during the group listening session. In some embodiments, the host user can control permissions for specific participant users.

In one example, a host media playback device belonging to a host user may be paired with a vehicle's entertainment system (via Bluetooth®, USB cord, aux cord etc.). After connecting to the vehicle's entertainment system, the host media playback device automatically establishes a group listening session. Other passengers in the vehicle may wish to discover and join the group listening session established by the host device in order to control the media playback of the group listening session. For example, a passenger may want to join the group listening session on their device in order to skip a media content item or adjust the volume of the media content item using the participant's device. This allows a plurality of passengers in the vehicle to control the media output of the vehicle from each of their respective devices.

In some embodiments, participant user devices join the group listening session established at the host device without needing to connect to a common network, such as a common Wi-Fi network. Instead, a server is accessed by each device via separate networks (e.g., two different cellular network connections, one Wi-Fi connection and one cellular connection, or two separate Wi-Fi connections) to facilitate the discovery of the group media playback session. This avoids the need to exchange network credentials and perform an initial connection/setup process. Advantages of not requiring participant devices to join a common network included improved network security and a streamlined set-up process. Additionally, the solution operates in scenarios where a Wi-Fi network is not available. For example, typically Wi-Fi is not available to a driver and passengers in a vehicle.

In some embodiments, the process for enabling participant devices to discover the playback session at the host device is automated. This is especially important in a vehicle setting because a driver does not need to perform any steps or provide any inputs to allow participant user devices to discover and join the media playback session.

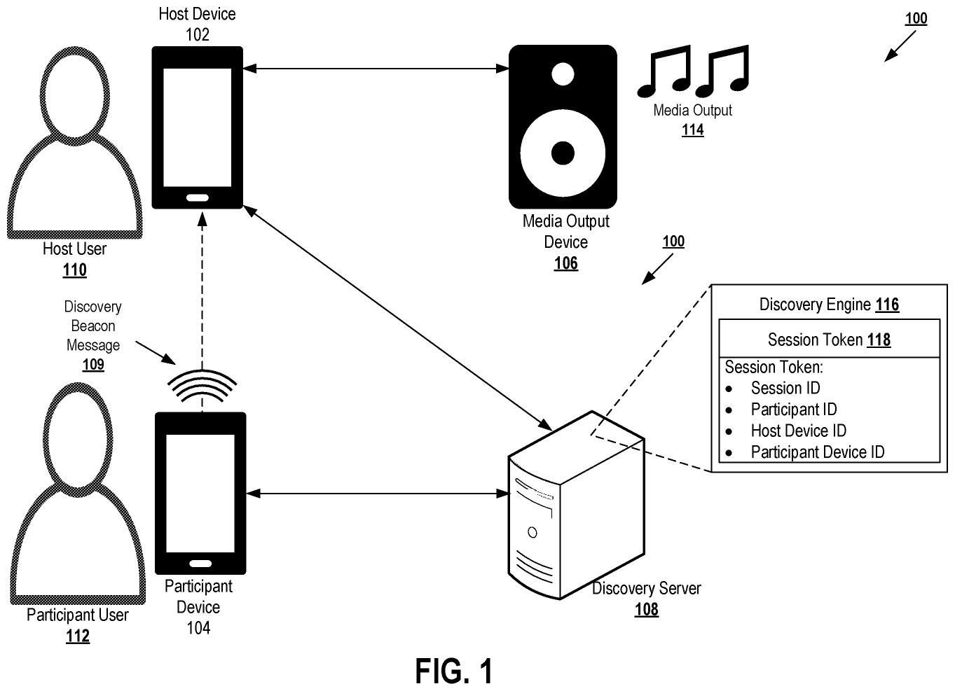

FIG. 1 illustrates an example environment 100 for discovering a group listening session. The environment 100 includes a host device 102 associated with a host user 110, a participant device 104 associated with a participant user 112, a media output device 106 configured to provide media output 114, and a discovery server 108 that operates a discovery engine 116. The discovery engine 116 manages session tokens including the session token 118.

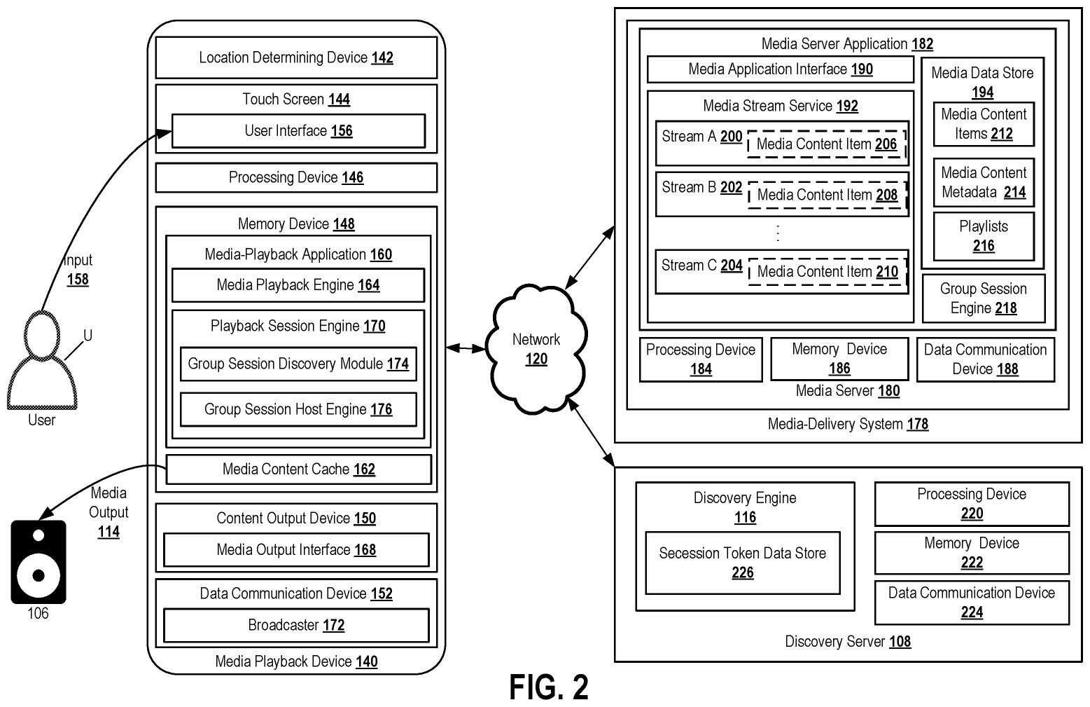

In some embodiments, the host device 102 refers to a computing device that is directly connected (either wired or wirelessly) to a media output device 106 or is a device which itself is outputting the media content through an integrated media output device. The host device 102 operates to play the media output 114 as part of a group media playback session. In some embodiments, the media content is provided by a media delivery system. For example, the media delivery system 178 illustrated and described in reference to FIG. 2. The host device 102 is configured to interface with a discovery server 108 to facilitate the discovery of the playback session from the participant device 104. Examples of the host device 102 include portable computing devices, smartphones, tablets, smart watches, smart speaker, head units in a vehicle, specialized devices configured to interface with an entertainment system of a vehicle, and other computing devices capable of media playback. The host user 110 is a user operating the host device.

The participant device 104 refers to a computing device which discovers and joins the group media playback session established at the host device 102 in order to control the media output 114. The participant device 104 is the device that the participant user 112 uses to join and control the media playback session. Examples of the participant device 104 include smart phones, tablets, smart watches, and other computing devices. The participant user 112 is the user operating the participant device 104. In typical embodiments, both the participant device 104 and the host device 102 each include a media content application for a media content provider.

In some embodiments, the host device 102 and/or the participant device 104 is a media playback device, such as the example media playback device 140 illustrated and described in reference to FIG. 2.

The media output device 106 is connected to the host device 102 to provide media content output 114. In some embodiments, the media output device 106 is wirelessly connected (e.g., via Bluetooth®). In other embodiments, the media output device 106 is connected via a communicating cable or wire (e.g., USB cable, AUX cord). In some embodiments, the media output device 106 is integrated with the host device 102. Non-limiting examples of media content output 114 include songs, albums, podcasts, other types of audio content, video content, audio-visual content, and portions or combinations thereof.

In some embodiments, the discovery beacon message 109 is a wireless transmission message which can be broadcast to devices in a local proximity. In some embodiments, the wireless transmission is sent using Bluetooth Low Energy (“BLE”), or another wireless standard. In some embodiments, the discovery beacon message 109 includes: (1) a media system identifier “ID” which is unique universal identifier associated with the media playback application (or the media content provider); and (2) a participant ID. In some embodiments one or both of these IDs are universally unique IDs. In some embodiments, the discovery beacon message 109 includes additional information, for example, user account info for the participant user 112. In some embodiments, the user account is not associated with the media content provider. For example, a user account from a separate media content provider can also be registered to join the group listening session to control the playback at the host device. For example, a live streaming event may allow users which do not have user accounts with the media content provider to control the playback at the host device using 3^{rd} party user account information or with no user account information. In some embodiments, the group session is a session imitated by a separate platform which is discoverable by users of the media content provider platform using the methods disclosed herein.

The discovery server 108 operates to allow the participant device 104 to discover the group listening session established at the host device 102. In typical embodiments, the host device 102 and the participant device 104 are connected to the discovery server 108 via separate network access points. For example, typically the host device 102 and the participant device 104 do not connect with the discovery server 108 via a common Wi-Fi network. An example of, the discovery server 108 is illustrated and described in reference to FIG. 2. The discovery server 108 operates a discovery engine 116.

The discovery engine 116 facilitates the discovery and joining of the participant device 104 to the media playback session of the host device 102. In some embodiments, the discovery server 108 periodically receives a query (sometimes referred to as a request or a discovery request) from the participant device 104 for playback sessions available to the participant device 104. The discovery server 108 receives a session token 118 from the host device and temporarily stores the session token 118. In some embodiments, the session token 118 defines a participant ID and a session ID, where the session token 118 and the session ID is generated by the host device and where the participant ID being identified by the host device scanning and identifying the discovery beacon message 109 broadcasted from the participant device 104. After the discovery engine 116 receives the session token 118 with the participant ID, the discovery engine 116 will reply with the session ID received from the host on future requests from the participant device. In some embodiments, the session ID is included in the next response to a request received at the discovery server 108 after the message with the participant ID is received. For example, if a session token includes the participant ID of the participant device 104, the discovery engine 116 instructs the discovery server 108 to send at least the session ID to the participant device 104 to allow the participant device 104 to discover and join the media playback session. In some embodiments, the server proactively sends a message with the session ID to the participant device associated with the participant ID.

In some embodiments, the discovery engine 116 includes a session token data store which temporarily stores session tokens. Each of the session tokens stored in the session token data store defines an association for a discoverable group listening session with the session ID, participant ID, host device ID (not required), and a participant device ID (not required). In typical embodiments, only the session Id and participant ID will be stored at the session token data store. In some embodiments, the participant ID is a randomly generated participant ID. For example, whenever the participant broadcasts a message the participant ID may be randomly generated. The participant ID may or may not be associated with a media content provider account. In some embodiments, the host device ID and participant device ID is hashed and/or filtered or otherwise encrypted, such that no genuine device identifying information is stored or can be decrypted at the discovery server 108. In some embodiments, the session token 118 is used to associate a participant with a nearby group listening session. In some embodiments, the session ID is generated by and received from the host device 102. In other embodiments, a separate backend server generates the session ID and is sent to the discovery server either directly or indirectly via the host device. In alternative embodiments, the discovery engine 116 generates the session ID. The session ID is sent to the participant device 104, thereby allowing the participant device 104 to discover the group listening session. The discovery engine 116 receives the participant ID from the host device 102, where the host device identifies the participant ID from a scanned discovery beacon message (e.g., the discovery beacon message 109) sent from the participant device. The participant ID is used to match session tokens with requests from the participant devices (such as the participant device 104). In some embodiments, other session information is sent to the participant device 104. For example, the host device ID or the IDs of other participants can be sent to the participant device 104.

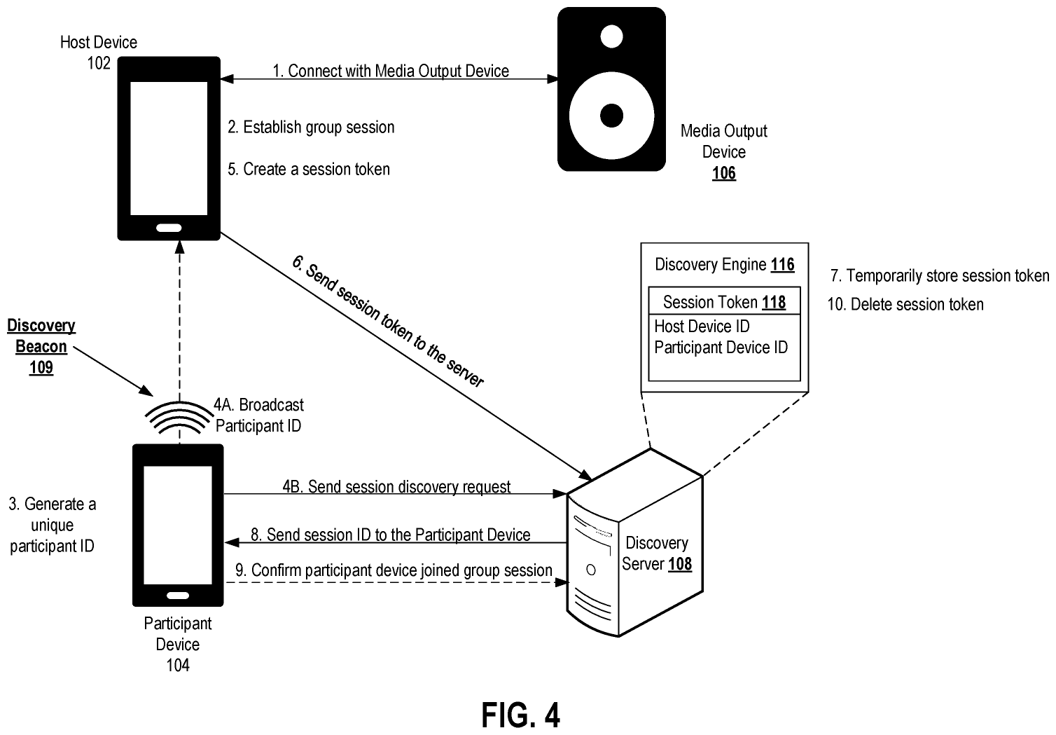

An example method for discovering a media playback session at the participant device 104 is illustrated and described as a system-flow diagram FIG. 4 as part of the environment 100.

In some embodiments, the participant device 104 provides the session ID to a media delivery server (e.g., the media delivery server 178 illustrated in FIG. 2) to join and control the group listening session. In some embodiments, the participant device sends commands with the session ID to the media delivery system to control the media playback at the host device. Similarly, the session ID is used to synchronize the participant device and the host device to a media playback state of the group listening session. The playback state can include a current song, volume, playback position, playlist, and other information about the playback of the group session. In alternative embodiments, the session ID is used by the participant device to directly send playback commands to the host device.

FIG. 2 is a schematic diagram of a group media playback discovery system. The media playback discovery system includes a media playback device 140, a media delivery system 178, and a discovery server 108.

The media playback device 140 is an example of the host device 102 or the participant device 104, as shown in FIG. 1. Some of the components illustrated with the media playback device 140 are optional. In some embodiments, the media playback device 140 plays media content items. In some embodiments, the media playback device 140 plays media content items that are provided (e.g., streamed, transmitted, etc.) by a system external to the media playback device 140, such as the media delivery system 178, another system, or a peer device. In some embodiments, the media playback device 140 plays media content items stored locally on the media playback device 140. Further in at least some embodiments, the media playback device 140 plays media content items that are stored locally as well as media content items provided by other systems. In some embodiments, the media playback device 140 receives commands for controlling a media playback at a different media playback device as part of a media playback session.

In some embodiments, the media playback device 140 is a portable computing device, such as a handheld entertainment device, smartphone, tablet, watch, wearable device, or any other type of device capable of playing media content. In some embodiments, the media playback device 140 is a laptop computer, desktop computer, or other computing counsel. In some embodiments, the media playback device 140 is an entertainment unit integrated in a vehicle. In some embodiments, the media playback device 140 is an entertainment unit designed to be installed and connected with a vehicle. Additionally, in some embodiments, the media playback device 140 is a smart speaker.

In the example shown the media playback device 140 includes a location determining device 142, a touch screen 144 with a user interface 156, a processing device 146, a memory device 148 storing instructions for a media playback application 160 and storing a media content cache 162, a content output device 150 with a media output interface 168, and a data communication device 152 with a broadcaster 172. The media playback application 160 includes a media playback engine 164 and a playback session engine 170. The playback session engine 170 includes a group session discovery module 174 and a group session host engine 176. Other embodiments may include additional, different, or fewer components.

In at least some embodiments, the media playback device 140 includes a location determining device 142. The location determining device 142 is a device that determines the location of the media playback device 140. In some embodiments, the location determining device 142 uses one or more of the following technologies: Global Positioning System (GPS technology, which receives GPS signals from a plurality of satellites, cellular triangulation technology, network based location identification technology, Wi-Fi® positioning systems technology, and combinations thereof. In some embodiments, the location information of the host user device and the participant user device is analyzed at the discovery server 108 to determine the devices are within a set proximity to allow the participant user device to join the playback session of the host user device. In some embodiments, the location data is sent to the discovery server 108 where it is analyzed by the discovery engine 116 to determine whether the host user device and participant user device are traveling in a same vehicle (e.g., based on a determined speed and movement in locations) and allow the participant to discover the playback session at the host device when it is determined that both devices are in the same vehicle. Similarly, if the location data indicates that the participant device is not in the car of the host device, the discovery engine 116 will not send the session information to the participant device, thereby preventing the participant device from discovering the media playback session.

The touch screen 144 operates to receive an input from a selector (e.g., a finger, stylus, etc.) controlled by the user U. In some embodiments, the touch screen 144 operates as both a display device and a user input device. In some embodiments, the touch screen 144 detects inputs based on one or both of touches and near-touches. In some embodiments, the touch screen 144 displays a user interface 156 for interacting with the media playback device 140. As noted above, some embodiments do not include a touch screen 144. Some embodiments include a display device and one or more separate user interface devices. Further, some embodiments do not include a display device (e.g., a smart speaker).

In some embodiments, the processing device 146 comprises one or more central processing units (CPU). In other embodiments, the processing device 146 additionally or alternatively includes one or more digital signal processors, field-programmable gate arrays, or other electronic circuits.

The memory device 148 typically includes at least some form of computer-readable media. Computer readable media includes any available media that can be accessed by the media playback device 140. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, Blueray® discs, digital versatile discs or other optical storage, magnetic cassettes, magnetic tape, magnetic disk storage or other magnetic storage devices, or any other medium that can be used to store the desired information and that can be accessed by the media playback device 140. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The memory device 148 operates to store data and instructions. In some embodiments, the memory device 148 stores instructions for a media playback application 160 and a media content cache 162.

In some embodiments, the media playback application 160 comprises a media playback engine 164 and a playback session engine 170.

The media playback engine 164 operates to play media content to the user. As described herein, the media playback engine 164 is configured to communicate with the media delivery system 178 to receive one or more tracks. In other embodiments, the media playback engine 164 is configured to play media content that is locally stored in the media playback device 140.

In some embodiments, the media playback application 160 includes a playback session engine 170. The playback session engine 170 operates a group media playback session. In some embodiments, the playback session engine 170 operates with the group session engine 218 to manage a group listening session, including managing the current media playback, updating the playback in response to commands from the host device or participant devices, managing a media playback state (e.g., current media content item, playback time, volume etc.), managing a group session state (e.g., group listening session name, participant names, host name, etc.) creating playlists, naming the group session, etc. In some embodiments, the group session state includes a media playback state. The playback session engine includes a group session discovery module 174 and a group session host engine 176. In alternative embodiments, the playback session engine 170 is a separate application from the media playback application 160.

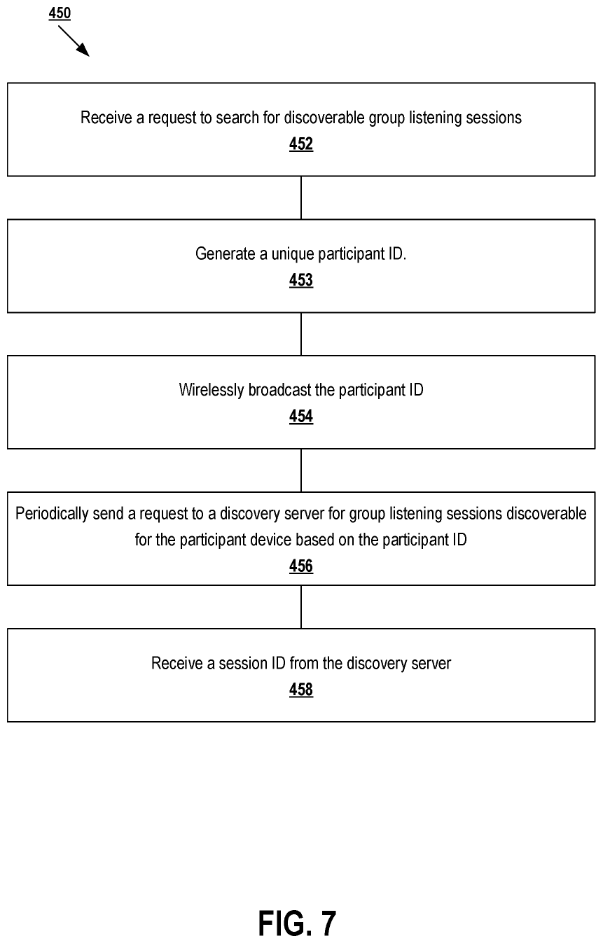

The group session discovery module 174 includes the logic for discovering, joining, and controlling a group session when the media playback device 140 is a participant device. In some embodiments, the group session discovery module 174 is integrated with the media playback application 160 including integrated UI elements for initiating a discovery of group listening session process. In some embodiments, the group session discovery module 174 generates a unique participant ID. In some embodiments, the group session discovery module 174 performs the method 450 illustrated and described in reference to FIG. 7. In some embodiments, the group session discovery module 174 interfaces with the broadcaster 172 to broadcast a participant ID. In some embodiments, the group session discovery module 174 interfaces with the data communication device 152 to send requests for discoverable group sessions to the discovery server 108. In some embodiments, after the media playback device 140 receives a session ID from the discovery server 108 and an input selecting to join a session associated with the session ID, the group session discovery module 174 provides the session ID to the media delivery system 178 such that the media playback device can control the group listening session via the group session engine 218.

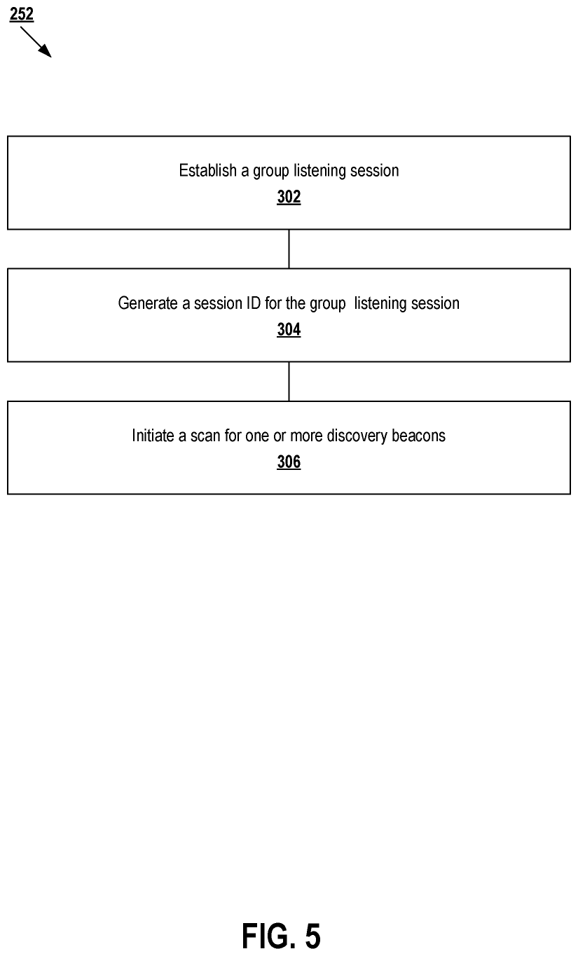

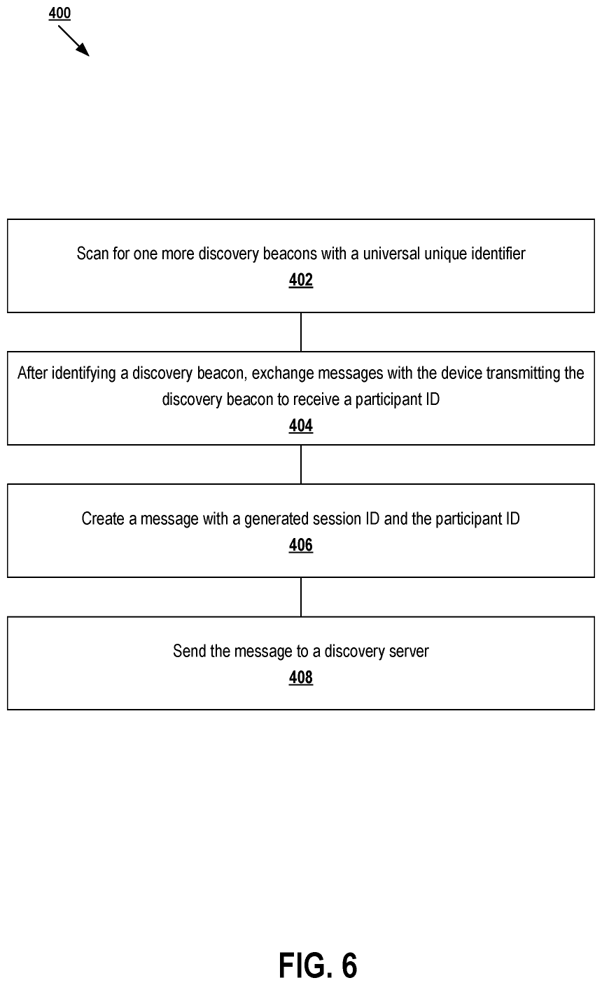

The group session host engine 176 manages the group listening session when the media playback device 140 is the host device. In some embodiments, the group session host engine 176 interfaces with the data communication device 152 to scan for discovery beacon messages. In some embodiments, the scan is after the group listening session is established. An example method for joining a participant to a group listening session at the host device is illustrated and described in reference to FIG. 6. In some embodiments, the group session host engine 176 automatically establishes a group listening session. For example, the group session may automatically be established when a criteria for establishing a group session is met. One example method 252 for establishing a group listening session is illustrated and described in reference to FIG. 5.

Some embodiments of the memory device 148 includes a media content cache 162. The media content cache 162 stores media content items, such as media content items that have been previously received from the media delivery system 178. The media content items stored in the media content cache 162 can be stored in an encrypted or unencrypted format. The media content cache 162 can also store metadata about the media content items such as title, artist, name, album name, length, genre, mood, era, etc. The media content cache 162 can also store playback information about the media content items, such as the number of times the user U has requested to playback the media content item or the current location of playback (e.g., when the media content item is an audiobook, podcast, movie, or the like for which a user may wish to resume playback.

The content output device 150 operates to output media content. In some embodiments, the content output device 150 generates the media content output 114 for the user(s).

The content output device 150 includes an external media output interface 168. The external media output interface 168 is configured to connect to the media playback device 140 to another system having one or more media output devices, such as a portable speaker or a vehicle entertainment system, so that the media content output 114 is generated via the media output device of the other system external to the media playback device 140. Examples of the external media output interface 168 includes an audio output jack, a USB port, a Bluetooth® transmitter, a display panel, and a video output jack. Other embodiments are possible as well. In one example, the external media output interface 168 interfaces with a speaker using a wireless protocol.

The data communication device 152 operates to enable the media playback device 140 to communicate with one or more computing devices over one or more networks, such as the network 120. For example, the data communication device 152 is configured to communicate with the media delivery system 178 and receive media content from the media delivery system 178 at least partially via the network 120. The data communication device 152 can be a network interface of various types which connects the media playback device 140 to the network 120. Examples of the data communication device 152 include wired network interfaces and wireless network interfaces. Wireless network interfaces can include or be implemented with technologies including infrared technology, BLUETOOTH® wireless technology, Bluetooth® low energy technology, 802.11a/b/g/n/ac technology, cellular technology, or radio frequency interface technology, among others. Examples of cellular network technologies include LTE, WIMAX, UMTS, CDMA2000, GSM, cellular digital packet data (CDPD), and MOBITEX. The data communication device 152 includes functionality for BLE device scanning which is used to identify the discovery beacon message broadcast from a potential participant device.

In some embodiments, the data communication device operates with a broadcaster 172. The broadcaster 172 transmits a discovery beacon message with a universal identifier and a participant ID. In some embodiments, the discovery beacon message is broadcast in a unidirectional format, such that a host device can scan and identify the data. In some embodiments, the discovery beacon message is broadcast using BLE and the universal identifier is unique is included in the attribute layer. In some embodiments, where the beacon is broadcast using BLE the participant ID is included the attribute layer.

The example system shown in FIG. 2 also includes a media delivery system 178. The media delivery system 178 comprises one or more computing devices and provides media content items to the media playback device 140 and, in some embodiments, other media playback devices as well. The media delivery system includes a media server 180. Although FIG. 2 shows a single media server 180, some embodiments include multiple media servers. In these embodiments, each of the multiple media servers may be identical or similar and may provide similar functionality (e.g., to provide greater capacity and redundancy, or to provide services from multiple geographic locations). Alternatively, in these embodiments, some of the multiple media servers may perform specialized functions to provide specialized services (e.g., services to enhance media content playback during travel, etc.). Various combinations thereof are possible as well.

The media server 180 transmits stream media to media playback devices such as the media playback device 140. In some embodiments, the media server 180 includes a media server application 182, a processing device 184, memory device 186, and the data communication device 188 may be similar to the processing device 146, memory device 158, and the data communication device 152 respectively, which have been previously described.

In some embodiments, the media server application 182 streams music or other audio, video, or other forms of media content. The media server application 182 includes a media stream service 192, a media data store 194, and a media application interface 190. The media stream service 192 operates to buffer media content such as media content items 206, 208, and 210, for streaming to one or more streams 200, 202, and 204. The streams are sent to one or more media playback devices over a stream media channel over the network 120.

The media application interface 190 can receive requests or other communication from media playback devices or other systems, to retrieve media content items from the media server 180. In some examples, the media application interface 190 operates to establish a communication channel with one or more media playback devices over the network 120.

In some embodiments, the media data store 194 stores media content items 212, media content metadata 214, and playlists 216. The media data store 194 may comprise one or more database and file systems. Other embodiments are possible as well.

As noted above, examples of the media content items 212 include audio, video, or any other type of media content, which may be stored in any format for storing media content.

The media content metadata 214 operates to provide various information associated with the media content items 212. In some embodiments, the media content metadata 214 includes one or more of title, artist name, album name, length, genre, mood, era, etc.

The playlists 216 operate to identify one or more of the media content items 212 associated with each other (e.g., as defined by a user administrator, criteria, ranking, etc.). In some embodiments, the playlists 216 identify a group of the media content items 212 in a particular order. In other embodiments, the playlists 216 merely identify a group of the media content items 212 without specifying a particular order. Some, but not necessarily all, of the media content items 212 included in a particular one of the playlists 216 are associated with a common characteristic such as a common genre, mood, or era. The playlists 216 may include user-created playlists, which may be available to a particular user, a group of users, or to the public.

Although not required, in some embodiments, the media server application 182 includes a group session engine. The group session engine 218 manages a group listening session. In some embodiments, the group listening session is managed with a group session state. In some embodiments, the group session engine 218 interfaces with the playback session engine 170 of the host device to track and update the group session state. In some embodiments, this includes providing the current media playback state to each participant device and updating the playback state by forwarding commands received from a participant device to the playback session engine 170 of the host device. In alternative embodiments, the playback state is managed at the media delivery system via the group session engine 218. In some embodiments, the group session engine 218 manages a group session state. In some embodiments, the group session state includes information such as the name of the group listening session, account names for participants of the group listening session, and account name for the host of the group listening session.

The system shown in FIG. 2 includes a discovery server 108. The discovery server 108 is another example of the discovery server 108 illustrated and described in reference to FIG. 1. In alternative embodiments, the discovery server 108 is included in the media delivery system 178 or as part of the media server 180. Although only a single discovery server 108, some embodiments include multiple discovery servers. In these embodiments, each of the multiple discovery servers may be identical or similar and may provide similar functionality (e.g., to provide greater capacity and redundancy, or to provide services from multiple geographic locations). Alternatively, in these embodiments, some of the multiple discovery servers may perform specialized functions to provide specialized services. Various combinations thereof are possible as well.

In the example shown, the discovery server includes a discovery engine 116, a processing device 220, a memory device 222, and a data communication device 224.

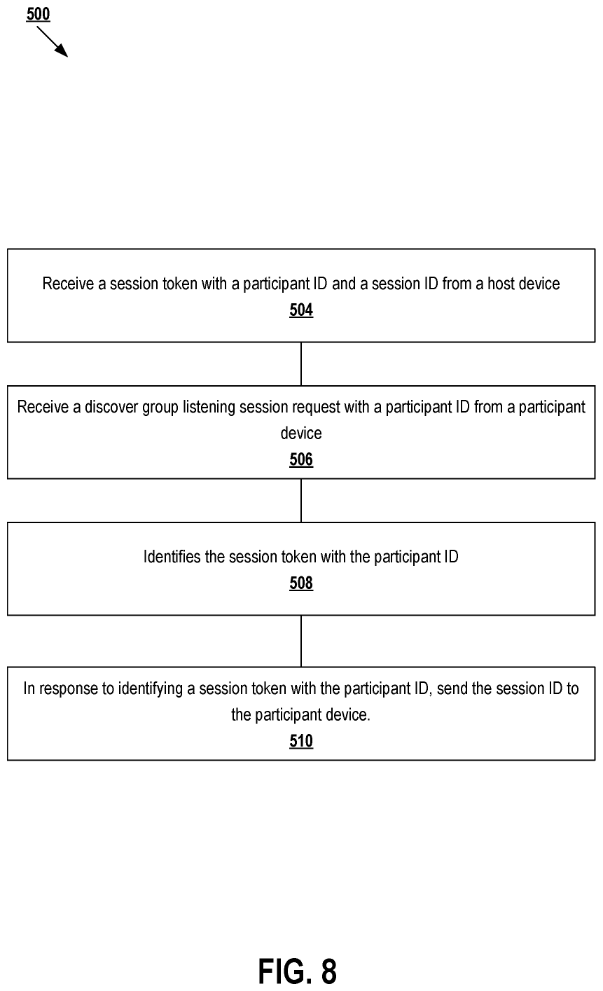

The discovery engine 116 facilitates the discovery and joining of participant devices to a group listening session of a host device. In some embodiments, the discovery engine 116 operates to provide discoverable group listening sessions to participant devices in response to receiving a request from said participant devices. In some embodiments, the discovery engine receives session tokens from host devices, each session token including a session ID and a participant ID. In some embodiments, the session token further includes the host device ID and/or the participant device ID (typically encrypted). The session tokens are temporarily stored in the session token data store. In some embodiments, the discovery engine 116 performs the method 500 illustrated and described in reference to FIG. 8.

In some embodiments, the discovery server proactively provides the session ID to nearby participant devices. For example, a participant device initiates a search for nearby group listening sessions while simultaneously (or near simultaneously) send a request to the discovery server with the participant ID. Once the discovery server receives a message with a session ID and the participant ID, the discovery server sends a discovery message to the participant device (e.g. without waiting for a request from the participant device). The participant device is able to discover the group listening session after receiving the discovery message from the discovery server.

The session token data store 226 temporarily stores session tokens. Each session token includes at least a session ID and a participant ID. The association defined by the session token with the session ID and the participant ID is used to define a group listening session discoverable by the participant device. In some embodiments, the session token includes additional information, such as a name of the group session, or an account name/ID of the host device. This information can be sent to a participant device to help the participant user select the correct group listening session. The participant ID is matched to requests sent with a participant ID sent from a participant device. In some embodiments, once the participant device joins the group session or when the participant device leaves a menu for discovering group listening sessions, a message is sent to the discovery server to delete the session tokens associated with the participant ID.

In some embodiments, the processing device 220, the memory device 222, and the data communication device 224 are similar to the processing device 146, the memory device 148, and the data communication device 152 respectively, which have each been previously described.

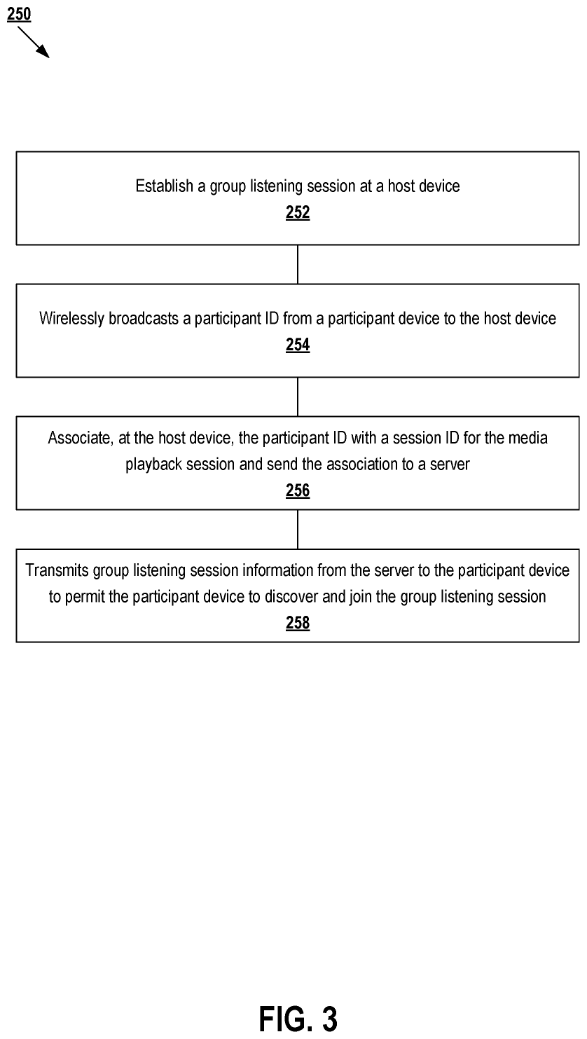

FIG. 3. illustrates an example method 250 for discovering a media playback session. In some embodiments, the example method 250 is performed in an environment similar to the environment 100 illustrated and described in reference to FIG. 1. The method 250 comprises the operations 252, 254, 256, and 258.

The operation 252 establishes a media playback session at a host device. In some embodiments, the media playback session is established automatically. In some embodiments, the group listening session is automatically established in response to identifying that a criteria for establishing a group listening session is met. For example, a media playback session can be automatically established when the host device connects to a media output device (e.g., an entertainment system in car). Other criteria can also be used. For example, the playback session may only be established when the host device connects with a specific media output device or a specific subset of media output devices, when the host device connects with a media output device and is connected (plugged-in) to a power source, when the host device is not connected to a Wi-Fi network, when the host device is connected to a wi-fi network, when the host device selects a media content item to play, when a particular media content item or collection of media content items (e.g., playlist) is selected for playback, based on the location data of the host device, or when the host device is determined to be in a vehicle, or any combination thereof. Many other examples of criteria for establishing a media playback session exist. In some embodiments, a host user provides a manual input to establish a media playback session. In some embodiments, establishing a media playback session includes generating a session ID, at the host device, and having the host device initiate a scan for participant IDs (e.g., by scanning for discovery beacon messages sent from a participant device). In some embodiments, once the media playback session is established the host device will periodically scan for participant IDs.

The operation 254 wirelessly broadcasts a participant ID from a participant device to the host device. In some embodiments, the participant ID is broadcast via a discovery beacon message which includes a universal unique identifier associated with the media content provider. For example, each instance of the media delivery application on different devices may store a global unique identifier which allows these devices to broadcast discovery beacon messages with the global unique identifier. The host device scans for the discovery beacon messages by searching for discovery beacon messages with the global unique identifier (e.g., via BLE messages including the global unique identifier in the unique identifier payload).

The operation 256 associates, at the host device, the participant ID with a session ID for the media playback session and sends the association to a server. In some embodiments, the association is created by generating a session token with the participant ID. In some embodiments, the host device analyzes the strength of the wireless signals from the participant device to determine if group listening session should be made accessible by the participant device. In some embodiments, a signal strength value is determined (e.g., in decibels) of and compared to a threshold value. In some embodiments, before registering the participant ID with the session by sending the session token to the server, the host device determines whether a signal strength of the wireless broadcast is greater than a threshold indicating that the participant device is in close proximity to the host device. In some embodiments, the threshold adjusts based on the environment of the group listening session. In some embodiments, the threshold may automatically adjust. For example, the threshold may be relatively high when the host device determines that it is connected to a vehicle entertainment system (e.g., because desired participant users are likely to also be located in the car and therefore in close proximity and a strong signal strength) compared to a lower threshold when it is determined that the host device is connected to an outdoor audio system (e.g., at a party). In other embodiments, a host user can manually adjust the threshold. Additional embodiments include combinations thereof.

The operation 258 transmits media playback session information from the server to the participant device to permit the participant device to discover and join the media playback session. In some embodiments, the participant device periodically sends requests for discoverable group listening sessions. In some embodiments, until the server receives a session token with the participant ID, the server responds to the request with a message indicating that there are no available group listening sessions. In other embodiments, the server does not respond to these requests if the server does not have a session token with the participants ID. In response to the first request received after the server receives a session token with the participant ID, the server will send the session ID of the session token to the participant user device. The session ID allows the participant device to discover the group listening session and, if desired, allows the participant user device to join the group listening session and control the playback at the host device.

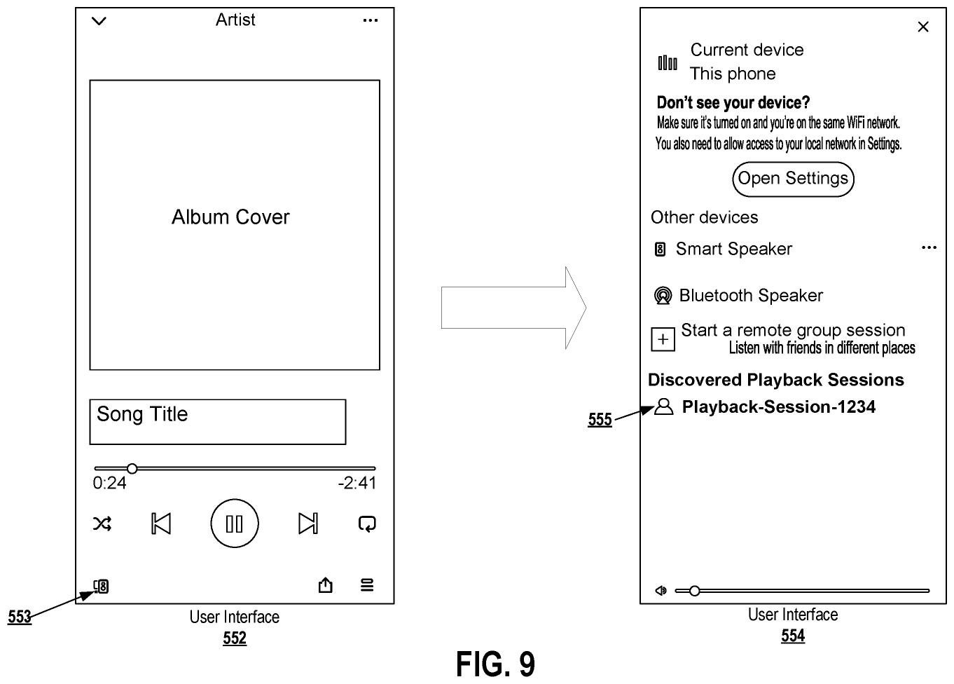

In some embodiments, a user interface (e.g., the user interface 554 illustrated in FIG. 9) presenting a list of available devices and playback sessions. In these embodiments a user can join a group listening session by selecting the desired and available group listening session presented in the user interface.

FIG. 4 is a system-flow diagram illustrating an example method for discovering a group listening session. The example shown, operates within the environment 100 illustrated and described in claim 1. In the example shown, the method for discovering group listening sessions includes at least 10 steps.

The method starts at step 1 where the host device 102 connects with a media output device 106. In some embodiments, this includes connecting the host device to a vehicle's entertainment system (e.g., either wired or wirelessly connected).

Step 2 establishes a group session. In some embodiments, the group session is automatically established after the host device 102 connects with the media output device 106. In other embodiments the group session is established in response to receiving a manual input. Once the group listening session is established, the host device 102 scans for discovery beacon messages. In some embodiments, the scan is done for set periods of time with set pauses to lower the energy demands of the scan.

At step 3, the participant device generates a unique participant ID. In some embodiments, the participant ID is generated in response to the participant user selecting an input to open a discover group listening session menu. In typical embodiments, each time the user opens the discover group listening session menu a new unique participant ID is generated. In some embodiments, the participant ID is randomly generated for one time user for joining a group listening session. In alternative embodiments, the participant ID is a static ID.

Next, the participant device simultaneously broadcasts discovery beacon messages at step 4A while sending periodic session discovery requests to the discovery server 108 at step 4B. In some embodiments, the discovery beacon message 109 is broadcast for a set period of time (e.g., 5 seconds) before pausing the broadcast for a second set period of time (e.g., 30 seconds) to improve the energy efficiency of the broadcasting. In some embodiments, steps 4A and 4B are continually performed until the participant device joins a group session. In some embodiments, the process continues until the user exits a discover group listening session menu. In some embodiments, the participant ID is broadcasted in a message with a global unique identifier associated with the media content provider and stored at both the host device 102 and the participant device 104.

At step 5 the host device creates a session token in response to identifying (via scan typically using BLE) a broadcasted participant ID. The host device 102 generates a unique session Id and associates the session ID with the participant ID to create the session token. The session token is sent to the discovery server 108 at step 6.

At step 6 the discovery server temporarily stores the session token. The session token is temporarily stored until (1) the participant device joins the group session, (2) the participant device stops seeking to discover a group listening session; and/or (3) the host device stops the group session.

After the discovery server 108 receives the session token, the discovery server sends the session ID to the participant device, as part of step 8, after the next discovery request is received from the participant device 104 (sent as part of the periodic step 4B). At step 9 the participant device 104 confirms that the participant device 104 has joined the group session and sends a message to the server to delete the session token at step 10 based on the server receiving a delete session token message. In typical embodiments, the server is agnostic to the reason for deleting the session token. In some alternative embodiments, the server receives an indication that the participant device has joined the group session and based on this indication deletes the session token associated with the participant ID.

FIG. 5 illustrates an example method 252 for establishing a discoverable group listening session. In some embodiments, the method 252 is performed on a host device, for example, the host device 102 as illustrated in the example of FIG. 1. The method 252 includes the operations 302, 304, and 306.

The operation 302 establishes a media playback session. In some embodiments, the operation 302 is another example of the operation 252 illustrated and described in reference to FIG. 3.

The operation 304 generates a session ID for the media playback session. In some embodiments, the session ID is a unique ID that is generated to create an association between a participant device and a group listening session. In some embodiments, the session ID is shared with a media delivery system to allow the participant device with the session ID to control the media playback at the host device as part of the group listening session. In other embodiments, the session ID is used as a credential to allow the participant device to directly send commands to the host device (e.g., via a BLE network) in order to control the media playback of the group listening session.

The operation 306 initiates a scan for one or more discovery beacon messages. In some embodiments, the scan is or a universal unique identifier associated with the media provider. For example, using a BLE protocol to identify locally broadcasted BLE messages. Messages with the universal unique identifier are scanned for and identified and the BLE protocol is used receive a participant ID from the participant device.

FIG. 6 illustrates an example method 400 for identifying and associating a participant with a group listening session. In some embodiments, the method 400 is performed on a host device, for example, the host device 102 as illustrated in the example of FIG. 1. The method 400 includes the operations 402, 404, and 406.

The operation 402 scans for a beacon with a universal unique identifier associated with the media content provider. In some embodiments, the beacon is a BLE message with an identifier which allows the host device to determine that the message was broadcast from a participant device searching for a group listening session.

After identifying a discovery beacon, the operation 404 exchange messages with the device transmitting the discovery beacon message to receive a participant ID. In some embodiments, the participant ID is located in the payload of the beacon message. In other embodiments, the participant ID is sent with a subsequent message or via different protocol layer.

The operation 406 creates a message with the generated session ID and the participant ID. The session token stores an association which allows the participant user to discover and join the group listening session.

The operation 408 sends a session token to a discovery server. The session token is typically sent to the discovery server via a network access point, such as a cellular network or a Wi-Fi-network. In some embodiments, if it is determined that the host device and participant device are connected to the same Wi-Fi network the operation 408 will perform a different operation to allow the participant device to join the group listening session.

FIG. 7 illustrates an example method 450 for discovering a group listening session from a participant device. In some embodiments, the method 450 is performed on a participant device, for example, the participant device 104 illustrated and described in reference to FIG. 1 or FIG. 2. The method 450 includes the operations 452, 453, 454, 456, and 458.

The operation 452 receives a request to search for discoverable group listening sessions. In some embodiments, joinable media playback device sessions include sessions hosted by devices within a broadcasting range of the participant device. In some embodiments, the operation 452 includes receiving a user input at the participant device to initiate the discovery of group media playback sessions.

The operation 453 generates a unique participant ID. In some embodiments, the participant ID is generated each time a user starts a broadcasting scenario. For example, when a user opens a group listening session discovery menu. In other embodiments, the participant ID is associated with a user account and/or a specific device of the participant user. In typical embodiments, the participant ID remains the same for the duration of the broadcasting for group listening sessions. In some embodiments to generate the participant ID includes generating a unique advertisement ID and retrieving a universal unique identifier for an associated media playback application, where the participant ID includes a beacon identifiable by the universal unique identifier with the unique advertisement ID encoded in a payload of the beacon. In some embodiments, the unique advertisement ID must be registered with the discovery server before wirelessly broadcasting the participant ID at the operation 454.

The operation 454 wirelessly broadcasts a participant ID. In some embodiments, the participant ID is broadcast over a BLE network. Other wireless network or communication protocols can also be used. In some embodiments, the participant ID includes broadcasting a discovery beacon. In some embodiments, the discovery beacon message is a BLE message.

The operation 456 periodically sends a request to a discovery server for group listening sessions discoverable for the participant device based on the participant ID. In some embodiments the operation 454 and 456 occur simultaneously until the user leaves the session discovery interface.

The operation 458 receives a session ID from the discovery server. In some embodiments, the session ID is sent with a URL to the session which allows the user to join the group session at a media delivery system. In some embodiments, the media delivery system includes an API which allows a user with a valid session ID to join and control a group listening session.

FIG. 8 is an example method 500 for managing the discovery of group listening sessions at a discovery server. In some embodiments, the method 500 is performed at the discovery server 108 as shown in FIG. 1 or FIG. 2. The method 500 includes the operations 504, 506, and 508.

The operation 504 receives a session token with a participant ID and a session ID from a host device. In some embodiments, the operation 504 receives additional session information. For example, a host device ID, information about the media output device, information about the current media playback (e.g., song, playback time, volume, etc.). In alternative embodiments, the operation 504 receives a participant ID and generates the session ID which is then sent back to the host device to initiate the media playback session.

The operation 506 receives a discover group listening session request with a participant ID from a participant device. In some embodiments, requests are periodically received until the participant device joins a group session or closes or leaves a group session discovery menu. In alternative embodiments, the discovery server proactively provides the session ID to nearby participant devices. For example, when the participant device initiates a search for nearby group listening sessions by broadcasting a randomly generated participant ID, it will simultaneously (or near simultaneously) send a request to the discovery server with the participant ID. The discovery server saves the participant ID and will proactively send a discovery message with a session ID to the participant in response to receiving a message with a session ID and the participant ID from the host device.

The operation 508 identifies the session token with the participant ID. In some embodiments, the operation 508 searches a session token data store for one or more session tokens with the participant ID.

The operation 510 sends the session ID to the participant device, in response to identifying a session token with the participant ID, thereby enabling the participant device to discover and join the media playback session.

FIG. 9 illustrates example user interfaces for discovering and joining a group media playback session. In some embodiments, the user interfaces 552 and 554 are displayed on a participant device as part of the media playback device application (e.g., the media playback application 160 shown in FIG. 2).

The user interface 552 is displayed to a participant user while the user is listening to a media content item and before the user has attempted to discover a group media playback session. The user presses a device connector input 533 to initiate the search for discoverable group media playback sessions. In one example, the participant provides the input selection of the device connector input 533 as part of the operation 452 as illustrated and described in FIG. 7.

After the device connector input 533 is selected the user interface 554 is presented and the participant device starts broadcasting a discovery beacon message while simultaneously sending requests to the discovery server with the participant ID. Once the discovery server responds to a request with a session ID, the session is displayed as discovered at a user interface element 555. A user can select the user interface element 555 to join the media playback session.

As used herein, the term “engine” is applied to describe a specific structure for performing specific associated functions, such as a special purpose computer as programmed to perform algorithms (e.g., processes) disclosed herein. The engine can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

Where data structures are referred to, the data structure can be stored on dedicated or shared computer readable mediums, such as volatile memory, non-volatile, transitory, or non-transitory memory.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

What is claimed is:

1. A method of controlling a media output device, the method comprising:
establishing a media playback session at a host device through the media output device;
wirelessly broadcasting a participant ID from a participant device to the host device;
associating, at the host device, the participant ID with a session ID for the media playback session and sending the association to a server; and
transmitting session information from the server to the participant device to permit the participant device to join the media playback session to adjust playback at the media output device.

2. The method of claim 1, wherein the wireless broadcast uses BLE.

3. The method of claim 1, wherein the host device and the participant device are not connected to a same local area network.

4. The method of claim 1, wherein before registering the participant ID with the media playback session at the server, the host device determines whether a signal strength of the wireless broadcast is greater than a threshold indicating that the participant device is in close proximity to the host device.

5. The method of claim 1, wherein a host user of the host device provides no input to initiate or authorize the participant device to join the media playback session.

6. The method of claim 1, wherein transmitting the session information occurs following a request being sent from the participant device to the server for the session information, wherein upon receipt of the request, the server determines that the participant device is associated with the media playback session using the participant ID and responds with the session information.

7. A user computing device comprising:
a processing device; and
a memory device storing instructions which, when executed by the processing device, cause the user computing device to:
receive a request to discover a nearby group listening session;
generate a participant ID;
wirelessly broadcasting the participant ID;
periodically send a discovery request to a server for discoverable group listening sessions; and
receive, from the server, a session ID;
wherein the session ID allows the user computing device to join a group listening session associated with the session ID;
wherein the session ID is generated at a computing device hosting the associated group listening session in response to scanning the wirelessly broadcasted participant ID; and
wherein the computing device hosting the associated group listening session sends the generated session ID and the wirelessly broadcasted participant ID to the server.

8. The user computing device of claim 7, wherein the participant ID is wirelessly broadcasted periodically for a set period of time with set pauses between each period.

9. The user computing device of claim 7, wherein the generated session ID and the wirelessly broadcasted participant ID are included in a session token.

10. The user computing device of claim 9, wherein the instructions further cause the user computing device to:
send a confirm receipt message in response to receiving the session ID to the server, wherein the server deletes the session token based on receipt of the confirm receipt message.

11. The user computing device of claim 9, wherein a confirm connection message is sent to the server after the user computing device joins the group listening session and the server deletes the session token in response to receiving the confirm connection message.

12. The user computing device of claim 7, wherein the participant ID is wirelessly broadcasted simultaneously with the discovery requests periodically sent to the server.

13. The user computing device of claim 7, wherein to generate the participant ID includes to:
generate a unique advertisement identifier; and
retrieve a universal unique identifier for an associated media playback application,
wherein the participant ID includes a beacon identifiable by the universal unique identifier with the unique advertisement ID encoded in a payload of the beacon.

14. The user computing device of claim 7, wherein to receive the request to discover the nearby group listening session includes to receive a user input at a user interface selecting a device connector element.

15. A user computing device hosting a group listening session, the user computing device comprising:
a processing device; and
a memory device storing instructions which, when executed by the processing device, cause the user computing device to:
establish the group listening session;
scan for a participant ID being wirelessly broadcasted from a participant device;
identify the participant ID;
generate a session ID; and
send the participant ID and the unique session ID to a server configured to provide the session ID to the participant device thereby allowing the participant device to discover and join the group listening session.

16. The user computing device of claim 15, wherein the group listening session is automatically established in response to identifying that a criteria for establishing group listening sessions is met.

17. The user computing device of claim 16, wherein the criteria includes one or more of:
(1) the user computing device is connected to an external media output device;
(2) the user computing device is connected to a power source;
(3) the user computing device is not connected to a Wi-Fi network;
(4) the user computing device is connected to a Wi-Fi network;
(5) the user computing device is determined to be a vehicle;
(6) location data of the user computing device;
(7) a particular media content item or collection of media content items is selected for playback; or
(8) any combination of (1), (2), (3), (4), (5), (6), and (7).

18. The user computing device of claim 16, wherein the group listening session ends when the criteria ceases to be met.

19. The user computing device of claim 15, wherein to scan for the participant ID includes scanning for a universal unique identifier associated with a media playback application on the user computing device, the media playback application managing the group listening session.

20. The user computing device of claim 15, wherein the user computing device is a specialized device for interfacing with an entertainment system of a vehicle.
